(19) United States
(12) Patent Application Publication
(10) Pub. No.: US 2004/0099359 A1
(43) Pub. Date: May 27, 2004

(54) Agricultural combine tire

(76) Inventor: Mark Leonard Bonko, Uniontown, OH (US)

Correspondence Address: The Goodyear Tire & Rubber Company, Patent & Trademark Department - D/823, 1144 East Market Street, Akron, OH, 44316-0001, US

(21) Appl. No.: 10/305,758

(22) Filed: Nov. 26, 2002

(51) Int. Cl. B60C 11/11; B 60C 1 7/02; B60C 121/00

(52) U.S. Cl. 152/209.12; 152/454

(57) ABSTRACT

A drive axle tire 20 for use on combines is disclosed. The tire 20 has a tread 32 with a plurality of lugs 50 extending to the equatorial centerplane wherein each lug has a lug length (lₗ), a lug height (lₕ) and a lug width (l_{w}). The lug width (l_{w}) is equal or greater than the lug height (lₕ) and the lugs 50 within each respective row are spaced apart a distance less than three times (l_{w}). The lugs are oriented at a low angle of less than 35° relative to the axial direction, the line K is preferably about 31°.

### FIELD OF THE INVENTION

This invention relates to agricultural tires, more specifically to a tire designed for very large combines used in crop harvesting.

### BACKGROUND OF THE INVENTION

Farm times have evolved over the years in an attempt to maximize tractor efficiency.

New tractors come with powerful lighting called stadium lighting that enables the farmers to work the field night and day.

Large combines have fuel tanks of up to 180 gallons and can operate for 14 to 16 hours straight before needing to refuel. These very large pieces of equipment such as combines weigh a considerable amount. For that reason the tires have to have a very strong carcass construction and tread lug design to carry the loads.

Historically, combines have a pair of small steering tires in the rear of the vehicle and larger drive axle tires in the front of the vehicle just aft of the cantilevered picker unit. Large combines most generally have four large drive axle tires. These drive axle tires propel the vehicle and push the cornheads and other crop harvesting headers into the crop as it is cut and harvested.

Traction performance must remain high and for that reason these tires have employed tractor tires having conventional directional tread patterns which provide maximum forward traction.

Combines weighing 10,000 to 15,000 pounds used treads having long bars that were arranged in two rows, extending from each tread shoulder crossing the centerline of the tire. These tires limited the number of lugs or bars that could come into ground contact with the vehicle.

A later generation of tires for the drive axle was developed that employed a combination of long bars and short bars in a chevron pattern in an effort to get more lugs in the footprint. Such a tire has been successfully used in the combine vehicles and is described in U.S. Pat. No. 4,534,392 assigned to The Goodyear Tire & Rubber Company and is sold commercially as the Dyna Torque II. As the combine's gross vehicle weight started to exceed 20,000 pounds the long bar/short bar tread pattern was becoming overstressed. In particular, while the increased number of lugs increased the leading edges this meant more driving torque could be transmitted to the vehicle. The torque generation is sufficiently large to cause a bending of the short lugs. The short lugs clearly assisted in providing more traction but they could under very high loads bend and roll over.

It is an object of the present invention to maintain the high tractive forces of the long bar/short bar tread pattern while keeping high tread lug contact area in the tire's footprint.

It is a further objective to improve the tread bar durability by employing a new tread pattern having stronger tread lugs.

### SUMMARY OF THE INVENTION

A drive axle tire for use on combines is disclosed. The tire has a carcass, a tread and may have a reinforcing belt or breaker structure. The carcass has at least one cord reinforced ply. The belt or breaker structure has a plurality of crossed belt or breaker layers.

The tread has a plurality of tread lugs extending radially outwardly from an inner surface of the tread called the non-skid surface to a radially outer top lug surface. The tread lugs are arranged in two circumferentially offset rows, a first row extending from a first shoulder toward the centerplane of the tread but not crossing the centerplane at the top lug surface. The second row extends from an opposite shoulder toward the centerplane of the tread but not crossing said centerplane at the top lug surface. This enhances wet soil mobility and unobstructed soil penetration. Each tread lug of said first row is similar in shape and is a mirror image of the tread lugs of the second row. Alternatively, the lugs could cross the centerplane in dry soil combine service.

Each lug has a minimum width (l_{w}) as measured between a leading edge and a trailing edge of the lug, a lug length (lₗ) as measured along a centerline of the lug midway between the leading edge and the trailing edge, an average radial height (lₕ) as measured from the non-skid surface to the radially outermost surface of the lug and wherein the minimum lug width is greater than or equal to the average radial height (lₕ) and the circumferential distance between the leading edge and the trailing edge of adjacent lugs within each row is less than or equal to 3 times (l_{w}), preferably about 2.6 times.

Each lug head has an axially inner end. At the axially inner end each lug has an enlarged lug head projecting from the leading edge.

Each lug has a circumferentially extending axially outer end and an inclined axially inner end oriented at an angle θ relative to the centerplane, θ being in the range of 30 to 60°. A line K, drawn between midpoints of the axially outer end and the axially inner end, is oriented at an angle β of less than 35° to the axial direction, the line K is preferably 31°.

### BRIEF DESCRIPTION OF THE DRAWINGS

The invention will be described by way of example and with reference to the accompanying drawings in which:

FIG. 1 is a perspective view of the preferred tire according to the present invention.

FIG. 2 is a plan view of the preferred tire according to the present invention.

FIG. 3 is a fragmentary view of the tread portion of the preferred tire according to the present invention.

FIG. 4 is a cross-sectional view of the preferred tire taken along lines 5-5 of FIG. 2.

FIG. 5 is a plan view of a portion of the contact patch of the preferred tire according to the present invention.

### DEFINITIONS

“Aspect ratio” of the tire means the ratio of its section height (SH) to its section width (SW) multiplied by 100% for expression as a percentage.

“Axial” and “axially” means lines or directions that are parallel to the axis of rotation of the tire.

“Bead” means that part of the tire comprising an annular tensile member wrapped by or otherwise anchored to ply cords and shaped, with or without other reinforcement elements such as flippers, chippers, apexes, toe guards and chafers, to fit the design rim.

“Belt or breaker reinforcing structure” means at least two layers of plies of parallel cords, woven or unwoven, underlying the tread, unanchored to the bead, and having both left and right cord angles in the range from 17 degrees to 33 degrees with respect to the equatorial plane of the tire.

“Bias-ply tire” means a tire having bias angle carcass, the angle of the cords being about 25° to 50° relative to the equatorial plane of the tire. Each adjacent ply has cords equal but oppositely oriented.

“Carcass” means the tire structure apart from the belt structure, tread, undertread, “and sidewall rubber over the plies, but including the beads.

“Circumferential” means lines or directions extending along the perimeter of the surface of the annular tread perpendicular to the axial direction.

“Design rim” means a rim having a specified configuration and width. For the purposes of this specification, the design rim and design rim width are as specified by the industry standards in effect in the location in which the tire is made. For example, in the United States, the design rims are as specified by the Tire and Rim Association. In Europe, the rims are as specified in the European Tyre and Rim Technical Organization—Standards Manual and the term design rim means the same as the standard measurement rims. In Japan, the standard organization is The Japan Automobile Tire Manufacturer's Association.

“Design rim width” is the specific commercially available rim width assigned to each tire size and typically is between 75% and 90% of the specific tire's section width.

“Equatorial plane (EP)” means the plane perpendicular to the tire's axis of rotation and passing through the center of its tread.

“Footprint” means the contact patch or area of contact of the tire tread with a flat surface at zero speed and under normal load and pressure.

“Inner” means toward the inside of the tire and “outer” means toward its exterior.

“Lateral edge” means the axially outermost edge of the tread as defined by a plane parallel to the equatorial plane and intersecting the outer ends of the axially outermost traction lugs at the radial height of the inner tread surface.

“Leading” refers to a portion or part of the tread that contacts the ground first, with respect to a series of such parts or portions, during rotation of the tire in the direction of travel.

“Net-to-gross ratio” means the ratio of the normally loaded and normally inflated tire tread rubber that makes contact with a hard flat surface, divided by the area of the tread, including non-contacting portions such as grooves as measured around the entire circumference of the tire.

“Normal inflation pressure” refers to the specific design inflation pressure and load assigned by the appropriate standards organization for the service condition for the tire.

“Normal load” refers to the specific design inflation pressure and load assigned by the appropriate standards organization for the service condition for the tire.

“Radial” and “radially” means directions radially toward or away from the axis of rotation of the tire.

“Radial-ply tire” means a belted or circumferentially restricted pneumatic tire in which the ply cords, which extend from bead to bead are laid at cord angles between 65° and 90° with respect to the equatorial plane of the tire.

“Section height” (SH) means the radial distance from the nominal rim diameter to the outer diameter of the tire at its equatorial plane.

“Section width” (SW) means the maximum linear distance parallel to the axis of the tire and between the exterior of its sidewalls when and after it has been inflated at normal pressure for 24 hours, but unloaded, excluding elevations of the sidewalls due to labeling, decoration or protective bands.

“Tire design load” is the base or reference load assigned to a tire at a specific inflation pressure and service condition: other load-pressure relationships applicable to the tire are based upon that base or reference.

“Trailing” refers to a portion or part of the tread that contacts the ground last, with respect to a series of such parts or portions during rotation of the tire in the direction of travel.

“Tread arc width” (TAW) means the width of an arc having its center located on the plane (EP) and which substantially coincides with the radially outermost surfaces of the various traction elements (lugs, blocks, buttons, ribs, etc.) across the lateral or axial width of the tread portions of a tire when the tire is mounted upon its designated rim and inflated to its specified inflation pressure but not subjected to any load.

“Tread width” means the arc length of the tread surface in the axial direction, that is, in a plane passing through the axis of rotation of the tire.

“Unit tread pressure” means the radial load borne per unit area (square centimeter or square inch) of the tread surface when that area is in the footprint of the normally inflated and normally loaded tire.

### DETAILED DESCRIPTION OF THE INVENTION

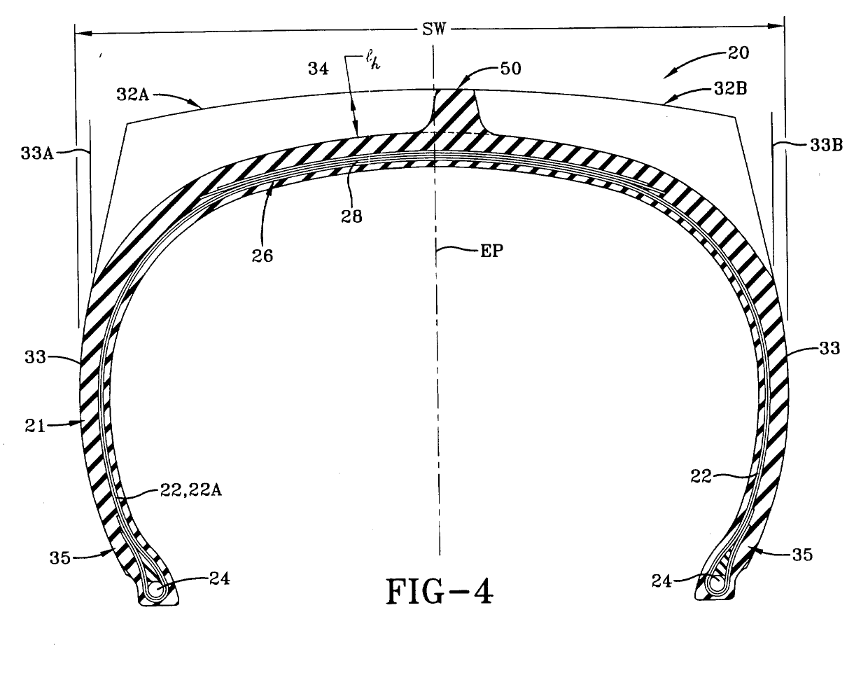

Now referring to FIG. 4, a tire is shown in cross-section view generally as reference numeral 20. The pneumatic tire 20 has a carcass 21 having one or more carcass plies 22 extending circumferentially about the axis of rotation of the tire 20. The carcass plies 22 are anchored around a pair of substantially inextensible annular beads 24. A belt or breaker reinforcing structure 26 comprising one or more belt or breaker plies 28 can be disposed radially outwardly from the carcass plies 22. The belt or breaker plies 28 provide reinforcement for the crown region of the tire 20. A circumferentially extending tread portion 32 is located radially outwardly of the belt reinforcing structure 26.

A sidewall portion 33 extends radially inwardly from each axial or lateral tread edge 33A, 33B of the tread to an annular bead portion 35 having the beads 24 located therein.

The carcass plies 22 preferably have textile or synthetic cords 22A reinforcing the plies 22. The cords 22A are preferably oriented radially in a single ply tire or if multiple plies are used then bias cords are employed. Most preferably, the cords 22A are made of polyester or nylon material. Typically, the tire 20 may have two to up to ten plies 22, each construction increasing in load carry capability as a function of the number of plies.

The belt or breaker reinforcement structure 26 if used preferably includes at least two belts 28 reinforced by synthetic cords of rayon or aramid.

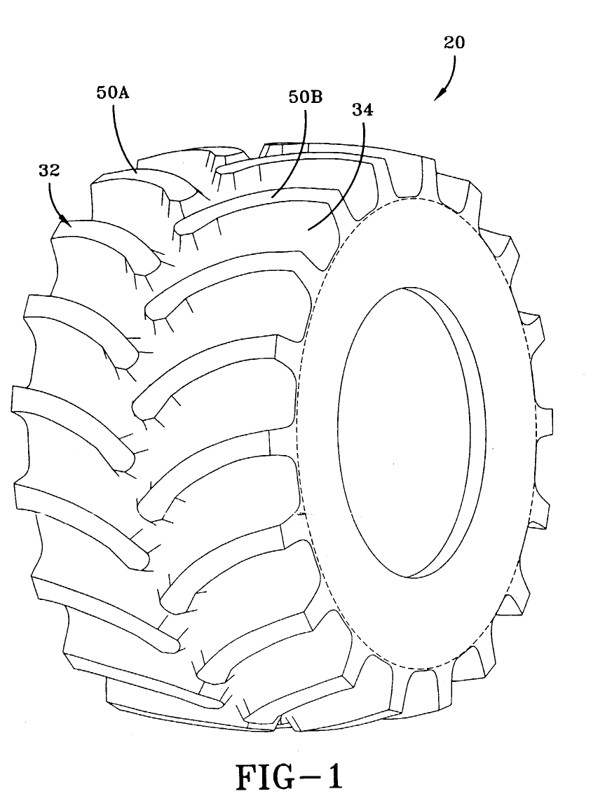

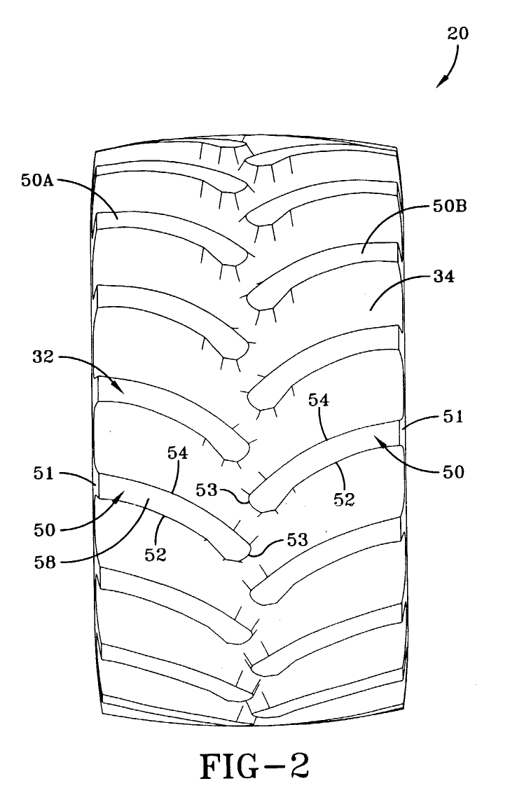

Now referring to FIGS. 1-5, a tire 20 according to the present invention is illustrated. The tire 20 according to the present invention has a unique tread 32. The tread 32 has a first lateral tread edge 33A and a second lateral tread edge 33B. Disposed between the tread edges 33A, 33B is an inner tread 34 and a plurality of lugs 50 arranged in two rows 50A and 50B extending radially outwardly from the inner tread 34. The tread 32 is divided into two tread halves 32A and 32B, respectively.

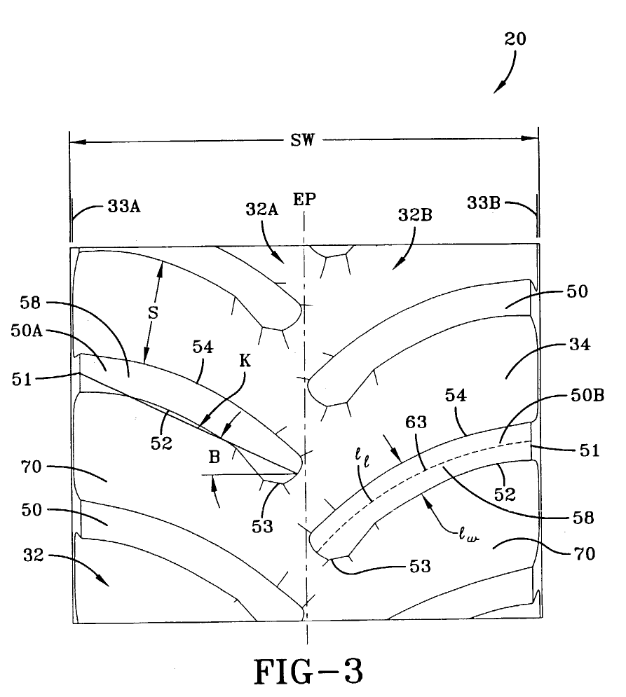

As illustrated in FIG. 3 each lug 50 has a radially outer surface 58, a leading edge 52, trailing edge 54 and a centerline 63 between the leading and trailing edges. Each lug 50 in rows 50A and 50B extends generally axially inwardly from an axially outer end 51 to an axially inner end 53. Each lug 50 intersects the equatorial plane EP along the lug wall of the axially inner end 53 and has an orientation substantially offset circumferentially with the lugs 50 of the opposite row as shown.

As illustrated in the radially outer surface 58 when viewed from the contact patch has a polygonal shape. The surface 58 exhibits the approximate orientation of the lug 50. For purposes of this invention the centerline 63 of the lugs is approximated by a line extending substantially parallel to the leading and trailing edges 52,54 and being generally equidistanced between these edges.

It is important to note that lugs have a length lₗ at least three times their width (l_{w}) whereas block elements have a width greater than one-third the length of the element. A lug for purposes of this invention has a length lₗ at least 10% of the section width (SW) of the tire 20.

The distance along the centerline 63 between the axially outer and inner ends 51,53 defines the length (lₗ) of the lug 50.

The distance extending substantially perpendicularly between the leading and trailing edges 52,54 of the lug define the lug width (l_{w}). The radial distance extending between the inner tread 34 and the edges 52,54 of the lug 50 defines the radial lug height (lₕ). Preferably, the ratio of the lug width (l_{w}) to lug radial heights (lₕ) is equal to or greater than 1.0 over at least 70% of the lug length (lₗ).

As shown in FIG. 4 the tire 20 has a very high net-to-gross ratio when compared to conventional farm tires. This is due in part to the wide surface area 58 of the lug 50 and the very large lug head 55 projecting from the leading edge 52 of the lug 50. Secondarily, by having the lugs 50 at the radial outer surface 58 extending toward but not crossing the equatorial centerplane of the tire 20 and being inclined at an angle β of less than 35′ means that many more lugs can be added around the circumference of the tire. When compared to a similar sized conventional long bar farm tire lugs oriented at about 45°, the tire of the present invention adds at least four lugs, six in some size tires.

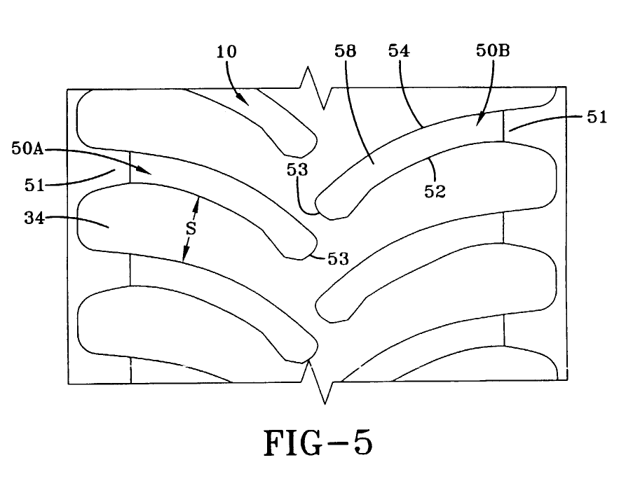

The lugs 50 as shown in FIGS. 3 and 5 have a line K extending between a midpoint of the axially inner end 53 and a midpoint of the circumferentially extending axially outer end 51. The line K is oriented at an angle β of 35° or less relative to the axial direction, as illustrated 31°.

The spacing S between the adjacent lugs 50 within a row 50A or 50B and the inner tread 34 defines a soil discharge channel 70. Tires designed for good mud traction have the distance between lugs at least 4 times the lug width (l_{w}).

The tire of the present invention has been designed to have this lug spacing distance reduced to less than three times the lug width (l_{w}), as shown 2.6 times. This greatly reduced channel width is possible because farmers avoid harvesting wet crops. Accordingly the stubble and the dry soil conditions enabled the tire 20 of the present invention to be designed with wide closely spaced lugs 50. The resultant net-to-gross ratio falls in the range of 29% to 35%, as illustrated about 29.5%.

The combine tires typically are made in two bias tire sizes, a 24.5-32 (24.5 R 32 for radial) and a 30.5 L-32 (30.5 LR32 for radial) or the metric eqivalent thereof. The total number of tread lugs in the 24.5-32 tire is proportional to the 30.5L-32 and in the 30.5L-32 tire fifty lugs are used. This amounts to at least two more lugs than the prior art tires.

Variations in the present invention are possible in light of the description of it provided herein. While certain representative embodiments and details have been shown for the purpose of illustrating the subject invention, it will be apparent to those skilled in this art that various changes and modifications can be made therein without departing from the scope of the subject invention. It is, therefore, to be understood that changes can be made in the particular embodiments described which will be within the full intended scope of the invention as defined by the following appended claims.

What is claimed is:

1. A drive axle tire for use on combines, the tire having a carcass reinforced by at least one cord reinforced ply and a tread having a plurality of tread lugs, the tire characterized by:
the tread lugs being arranged in two circumferentially offset rows, a first row extending from a first shoulder toward the centerplane of the tread but not crossing said centerplane, a second row extending from an opposite shoulder toward the centerplane of the tread but not crossing said centerplane, each tread lug of said first row being similar in shape and a mirror image of the tread lugs of the second row; wherein each lug has a minimum width (l_{w}) as measured between a leading edge and a trailing edge of the lug, a lug length (lₗ) as measured along a centerline of the lug midway between the leading edge and the trailing edge, and an average radial height (lₕ) as measured from the non-skid surface to the radially outermost surface of the lug and wherein the minimum lug width (l_{w}) is greater than or equal the average radial height (lₕ) and the circumferential distance between the leading edge and the trailing edge of adjacent lugs within each row is less than or equal to 3 times (l_{w}).

2. The tire of claim 1 wherein the axially inner end of each lug has an enlarged lug head projecting from the leading edge.

3. The tire of claim 1 wherein each lug has a circumferentially extending axially outer end and an inclined axially inner end oriented at an angle θ relative to the centerplane, θ being in the range of 30° to 60°.

4. The tire of claim 2 wherein a line K drawn between midpoints of the axially outer end and the axially inner end is oriented at an angle β of less than 35° to the axial direction.

5. The tire of claim 4 wherein the line K is oriented at an angle β of 31°.

6. The tire of claim 1 wherein the tire size is 30.5L-32 and the total of lugs number fifty around the circumference of the tire.
